(19) United States
(12) Patent Application Publication
(10) Pub. No.: US 2011/0049421 A1
(43) Pub. Date: Mar. 3, 2011

(54) COMPOSITIONS AND PROCESSES FOR MAKING THE SAME

(75) Inventors: Robert J. Dobbs, Newfield, NY (US); Sandra Brosious, Vestal, NY (US); Archit Lal, Ithaca, NY (US)

(73) Assignee: Primet Precision Materials, Inc., Ithaca, NY (US)

(21) Appl. No.: 12/868,933

(22) Filed: Aug. 26, 2010

Related U.S. Application Data
(60) Provisional application No. 61/237,767, filed on Aug. 28, 2009.

(51) Int. Cl. H01M 4/90; C01B 25/30

(52) U.S. Cl. 252/182.1; 423/306

(57) ABSTRACT

Compositions and processes of for forming the same are described. In some embodiments, the compositions include lithium-based compounds which may be used as electrode materials in electrochemical cells including batteries.

### RELATED APPLICATIONS

This application claims priority to U.S. Provisional Application No. 61/237,767, filed Aug. 28, 2009, which is incorporated herein by reference in its entirety.

### FIELD OF INVENTION

The invention relates generally to compositions and processes of for forming the same. In some embodiments, the compositions include lithium-based compounds which may be used as electrode materials in electrochemical cells including batteries.

### BACKGROUND OF INVENTION

Compounds may be produced in solid state reactions in which precursors are caused to react by heating to a sufficient temperature and for a sufficient time. Lithium-based compounds, such as lithium metal phosphates (e.g., LiFePO₄) and lithium metal oxides (e.g., LiMnNiO₂), may be produced using solid state reactions. These lithium-based compounds may be used in electrochemical cells such as batteries. The compounds may be processed, for example, to form powders that are used to form electrodes (e.g., anode, cathode) of the cell. There is a desire in the art to improve electrochemical performance in cells including increased charging/discharging rates, increased power density and increased operational lifetime.

Milling processes typically use grinding media to crush, or beat, a product material to smaller dimensions. For example, the product material may be provided in the form of a powder having relatively large particles and the milling process may be used to reduce the size of the particles. Some processes may involve milling lithium-based compounds.

Grinding media may have a variety of sizes and shapes. In a typical milling process, the grinding media are used in a device known as a mill (e.g., ball mill, rod mill, attritor mill, stirred media mill, pebble mill). Mills typically operate by distributing product material around the grinding media and rotating to cause collisions between grinding media that fracture product material particles into smaller dimensions to produce a milled particle composition.

### SUMMARY OF INVENTION

Compositions and processes of for forming the same are provided.

In one aspect, a method is provided. The method comprises reacting a first precursor with a second precursor to form a partially reacted composition. The method further comprises processing the partially reacted composition using a milling step.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIG. 1 is an XRD curve of a partially reacted lithium iron phosphate composition as described in Example 1.

FIGS. 2-4 are XRD curves of a fully reacted lithium iron phosphate compositions as described in Example 1.

### DETAILED DESCRIPTION

Processes for making compounds are described. The processes generally involve providing precursors (e.g., precursor particles) and causing them to partially react to form a partially reacted composition. The partially reacted composition is then further processed, for example, to reduce particle size. In some embodiments, a milling process is used to reduce the particle size, as described further below. In some cases, the milled composition may then be subjected to a second reaction step to form the final reaction product composition. In some cases, the partially reacted composition may be converted to the final reaction product in the milling process, itself. In some embodiments, the final composition is a lithium-based compound. Such lithium-based compounds may be used in a variety of different applications including energy storage, energy conversion, and/or other electrochemical applications. In some embodiments, the composition is particularly suitable for use as electrode materials in batteries.

As used herein, a “lithium-based compound” is a compound that comprises lithium and one or more additional elements. Examples of suitable lithium-based compounds include lithium phosphate-based compounds (i.e., compounds that comprise lithium and a phosphate group (PO₄) and may comprise one or more additional elements); lithium oxide-based compounds (i.e., compounds that comprise lithium and oxygen and may comprise one or more additional elements); and, lithium titanate-based compounds (i.e., compounds that comprise lithium and titanium and may comprise one or more additional elements). For example, suitable lithium phosphate-based compositions may have the general formula LiMPO₄, where M may represent one or more metals including transition metals such as Fe, Mn, Co, Ni, V, Cr, Ti, Mo and Cu. Examples of suitable lithium phosphate-based compositions include LiFePO₄, LiMnPO₄ and LiFeMnPO₄. Suitable lithium oxide-based compositions may have the general formula LiₓMO_{y}, where x and y are a suitable subscripts (e.g., 1, 2, 3) and M may represent one or more metals including transition metals such as Fe, Mn, Co, Ni, V, Cr, Ti, Mo and Cu. Examples of suitable lithium oxide-based compositions include lithium cobalt oxide, lithium manganese oxide, lithium nickel manganese oxide, lithium nickel manganese cobalt oxide, or lithium nickel cobalt aluminum oxide. Suitable lithium titanate-based compositions include Li₄Ti₅O₁₂, amongst others. Lithium nickel manganese cobalt oxide or lithium nickel cobalt aluminum oxide may also be suitable. Suitable lithium-based compound compositions have been described in U.S. Pat. Nos. 5,871,866; 6,136,472; 6,153,333; 6,203,946; 6,387,569; 6,387,569; 6,447,951; 6,528,033; 6,645,452; 6,667,599; 6,702,961; 6,716,372; 6,720,110; and, 6,724,173 which are incorporated herein by reference.

It should be understood that the processes described herein are not limited to production of lithium-based compounds. Other types of compounds are also possible. Other types of compounds may include other types of battery materials. Other compounds may include iron-based compounds. In some embodiments, the compounds are ceramics.

In general, the precursors are selected to provide the desired final reaction composition. In some embodiments, one precursor type comprises lithium, i.e., is a lithium-containing compound, and a second type comprises other elements. Suitable lithium-containing precursors include lithium carbonate, lithium acetate, lithium dihydrogen phosphate, lithium hydroxide, lithium nitrate, or lithium iodide. Other suitable precursors include aluminum nitrate, ammonium dihydrogen orthophosphate, ammonium monohydrogen orthophosphate, cobalt hydroxide, cobalt nitrate, cobalt oxide, iron acetate, iron oxide, iron phosphate, manganese acetate, manganese carbonate, manganese hydroxide, manganese oxide, nickel hydroxide, nickel nitrate, nickel oxide, or titanium oxide.

It should be understood that other precursors may be used and that, in some methods, more than two types of precursors may be used.

The precursors may be in particle form. In some embodiments, the precursor particles may be selected to have small particle size (e.g., less than 500 nm). In some cases, the use of small size precursor particles can increase the efficiency of the process, amongst other advantages.

As noted above, the methods may include a step in which the precursors are partially reacted. Prior to (and/or during) the reaction step, the methods may involve mixing the appropriate precursors to form a mixture. In some cases, the precursors may be mixed using a milling process. In some embodiments, a mill may be used to mill the precursor particles to smaller particle sizes (e.g., less that 1 micron), or to mix the precursor particles without substantially further reducing particle size. In some embodiments, the precursor particles may also be deagglomerated during milling.

The precursors may optionally be mixed in a fluid carrier during milling, such as water, N-methyl pyrrolidinone, alcohols (e.g., isopropanol), or the like. In some embodiments, at least a portion of (e.g., at least one component of) one of the precursors may be is dissolved in a fluid carrier.

It should be understood that not all processes involve milling the precursors. In other embodiments, the mixture may not be mixed using a mill, but may be mixed using other techniques (e.g., stirring, sonication).

As noted above, the methods may involve causing a partial reaction between the precursors (e.g., precursor particles) to occur. That is, the precursors do not completely react in this step to form the desired final reaction product. Thus, the partially reacted product includes the final reaction product phase (e.g., olivine phase lithium phosphate-based compounds such as LiFePO₄) and impurity phase(s). The impurity phases may be unreacted precursor and/or intermediate reaction products. For example, the partially reacted product may include greater than 5% by weight of impurity phase(s) (e.g., between 5% and 90%, between 5 and 50% by weight), greater than 20% by weight (e.g., between 20% and 90%, between 20 and 50% by weight), greater than 40% by weight (e.g., between 40% and 90%, between 40 and 60% by weight), greater than 60% by weight (e.g., between 60% and 90%, between 60 and 75% by weight), or greater than 80% by weight of the impurity phase(s). The weight percentages of the final reaction product phase and impurity phases may be determined using XRD (x-ray diffraction) techniques. The specific impurity phases that are present depend on the precursors, as well as the reaction conditions. In some cases, the impurity phases are non-olivine phases.

During the partial reaction step, in some embodiments, the precursor mixture is heated to an appropriate temperature to cause a solid state reaction between precursor particles. In general, the conditions are selected so that the reaction proceeds partially but not to completion. For example, the precursors can be heated at a temperature of at least 400° C. (e.g., between 400° C. and 800° C.). In some cases, the precursors can be heated at a temperature of at least 600° C., at least 700° C. Other temperatures may also be used.

During the partial reaction step, the precursor mixture is heated for an appropriate time. Suitable times include 1 to 4 hours, though it should be understood that other times are also possible.

In some embodiments, the partially reacted product may be brittle. For example, the partially reacted product may be more brittle than final product. This brittleness can be an advantage, for example, in embodiments in which the partially reacted product is further processed by milling, as described further below, since milling performance can be improved by the brittleness.

As noted above, the partially reacted particles may be further processed. Further processing may involve imparting the partially reacted particles with desirable characteristics. For example, the particle size may be reduced, as described further below. In some cases, further processing may product a composition having the desired phase (e.g., olivine phase lithium-based compounds).

In some cases, further processing involves milling the partially reacted particles. The processes may utilize a wide range of conventional mills having a variety of different designs and capacities. Suitable types of mills include, but are not limited to, ball mills, rod mills, attritor mills, stirred media mills, pebble mills, vibratory mills, and jet mills, amongst others.

In some milling processes, the partially reacted particles are introduced as feed material (e.g., feed particles) into the mill. The feed material may be introduced along with a milling fluid (e.g., a fluid that does not react with the reaction product particles) in the form of a slurry into a processing space in a mill in which grinding media are confined. The viscosity of the slurry may be controlled, for example, by adding additives to the slurry such as dispersants. The mill is rotated at a desired speed and material particles mix with the grinding media. Collisions between the particles and the grinding media can reduce the size of the particles and impart other characteristics. The particles are typically exposed to the grinding media for a certain mill time after which the milled material is separated from the grinding media using conventional techniques, such as washing and filtering, screening or gravitation separation.

In some processes, the slurry of particles is introduced through a mill inlet and, after milling, recovered from a mill outlet. The process may be repeated and, a number of mills may be used sequentially with the outlet of one mill being fluidly connected to the inlet of the subsequent mill.

It should be understood that not all methods utilize a milling processes and that the partially reacted particles may be processed in other ways.

In some embodiments, it may be desirable to use a high specific milling energy input. Specific milling energy input is a measure of the milling energy consumed per weight of product material. For example, the specific milling energy input may be greater than 10,000 KJ/Kg; in some embodiments, greater than 20,000 Kj/Kg; and, in some embodiments, greater than 40,000 KJ/Kg.

In certain milling processes, it may be preferred to use grinding media having specific characteristics. However, it should be understood that not every embodiment of the invention is limited in this regard. Suitable grinding media compositions have been described, for example, in U.S. Patent Publication No. US2006/0003013 and U.S. Pat. No. 7,140,567, which are incorporated herein by reference. In some embodiments, the process may utilize more than one milling step which may use different grinding media. For example, the initial milling step may utilize a standard grinding media (e.g., YSZ), while subsequent milling steps may utilize more advanced grinding media such as those described in the patents incorporated by reference above.

In some embodiments, the grinding media is formed of a material having a high density, a high fracture toughness, and a high hardness. In general, the average size of the grinding media is between about 0.5 micron and 10 cm. In certain embodiments, it may be advantageous to use grinding media that are very small. It may be preferred to use grinding media having an average size of less than about 250 microns; or, less than about 150 microns (e.g., between about 75 and 125 microns). In some cases, the grinding media may have an average size of less than about 100 microns; or even less than about 10 microns. In some cases, the grinding media may have an average size of greater than 0.5 micron.

The grinding media may also have a variety of shapes. In some embodiments, it is preferred that the grinding media be substantially spherical (which may be used herein interchangeably with “spherical”).

In some embodiments, the grinding media may be formed of a ceramic material such as a carbide material. In some embodiments, the grinding media to be formed of a single carbide material (e.g., iron carbide (Fe₃C), chromium carbide (Cr₇C₃), molybdenum carbide (Mo₂C), tungsten carbide (WC, W₂C), niobium carbide (NbC), vanadium carbide (VC), and titanium carbide (TiC)). In some cases, it may be preferred for the grinding media to be formed of a multi-carbide material. A multi-carbide material comprises at least two carbide forming elements (e.g., metal elements) and carbon.

A multi-carbide material may comprise a multi-carbide compound (i.e., a carbide compound having a specific stoichiometry; or, a blend of single carbide compounds (e.g., blend of WC and TiC); or, both a multi-carbide compound and a blend of single carbide compounds. It should be understood that multi-carbide materials may also include other components such as nitrogen, carbide-forming elements that are in elemental form (e.g., that were not converted to a carbide during processing of the multi-carbide material), amongst others including those present as impurities. Typically, but not always, these other components are present in relatively minor amounts (e.g., less than 10 atomic percent).

It should be understood that other types of grinding media may be used.

In some embodiments, the particle size of the partially reacted particles may be reduced during the further processing step (e.g., milling). For example, the particle size may be reduced to an average particle size of 500 nm or less. In certain embodiments, the average particle size may be reduced to even smaller values. For example, the average particle size may be reduced to less than 250 nm, less than 150 nm, less than 100 nm, less than 75 nm, or less than 50 nm. In some embodiments, it may be preferred for the partially reacted particles to have very small particle sizes (e.g., an average particle size of less than 100 nm). Such particle sizes may be obtained, in part, by using grinding media having the above-described characteristics.

It should be understood that not all embodiments involve reducing the particle size of the partially reacted particles within the above-noted ranges.

It should be understood that the average particle size of a reaction product particle is the average primary particle size of the reaction product and may be determined by measuring an average cross-sectional dimension (e.g., diameter for substantially spherical particles) of a representative number of primary particles. For example, the average cross-sectional dimension of a substantially spherical particle is its diameter; and, the average cross-sectional dimension of a non-spherical particle is the average of its three cross-sectional dimensions (e.g., length, width, thickness), as described further below. The particle size may be measured using a laser particle measurement instrument, a scanning electron microscope or other conventional techniques.

Some embodiments may include partially reacted particles having uniform particle size distribution, i.e., a narrow particle size distribution. For example, the partially reacted particles may also be relatively free of large particles. That is, the partially reacted particles may include only a small concentration of larger particles. In some embodiments, the partially reacted particles may exhibit a unimodal particle distribution. In some cases, the D₉₀ values for the compositions may be any of the above-described average particle sizes. Though, it should be understood that the invention is not limited to such D₉₀ values.

The partially reacted particles may also have a very high average surface area after the further processing step. The high surface area is, in part, due to the very small particle sizes noted above. The average surface area of the reaction product particles may be greater than 1 m²/g; in other cases, greater than 5 m²/g; and, in other cases, greater than 50 m²/g. In some cases, the particles may have extremely high average surface areas of greater than 100 m²/g; or, even greater than 500 m²/g. It should be understood that these high average surface areas are even achievable in particles that are substantially non-porous, though other particles may have surface pores. The surface area may be measured using such as BET measurement techniques.

Amongst other advantages, the small particle size and/or high surface areas may increase efficiency of further processing.

In some embodiments, the partially reacted particles may be in the form of an agglomerate of particles. As used herein, agglomerates of particles are referred to as “agglomerates”. The agglomerate may comprise a plurality of particles (e.g., lithium-based compound particles) as described herein, and may have an average agglomerate size that is 50 microns or less, 25 microns or less, or 10 microns or less. In some embodiments, the agglomerate of particles may have an average agglomerate size that is in the range of 1-25 microns, 1-10 microns, or, 2-8 microns. It should be understood that the average agglomerate size may be determined by measuring an average cross-sectional dimension (e.g., diameter for substantially spherical agglomerates) of a representative number of agglomerates. The agglomerate size may be measured using a scanning electron microscope or other conventional techniques.

As noted above, the partially reacted particles may be processed using a milling process. Thus, these reaction product particles may be described as having a characteristic “milled” morphology/topology. Those of ordinary skill in the art can identify “milled particles,” which, for example, can include one or more of the following microscopic features: multiple sharp edges, faceted surfaces, and being free of smooth rounded “corners” such as those typically observed in chemically-precipitated particles. It should be understood that the milled particles described herein may have one or more of the above-described microscopic features, while having other shapes (e.g., platelet) when viewed at lower magnifications. In some cases, the reaction product particles may have a spherical or equiaxed morphology.

In some embodiments, it may be preferable for the partially reacted particles to have a substantially equiaxed shape. Other shapes may also be preferable including platelet shapes. In these cases, the particles may have a relatively uniform thickness across the length of the particle. The particles may have a substantially planar first surface and a substantially planar second surface with the thickness extending therebetween. The particle thickness may be smaller than the particle width and particle length. In some embodiments, the length and width may be approximately equal; however, in other embodiments the length and width may be different. In cases where the length and width are different, the platelet particles may have a rectangular box shape. In certain cases, the particles may be characterized as having sharp edges. For example, the angle between a top surface (e.g., first planar surface) of the particle and a side surface of the particle may be between 75° and 105°; or between 85° and 95° degrees (e.g., about 90°).

In some embodiments, the partially reacted particles may have a substantially spherical or oblate spheroid shape, a substantially equiaxed shape, a substantially platelet shape, a substantially rod-like shape, amongst others. It should be understood that within a partially reacted particle composition, individual particles may be in the form of one or more of the above-described shapes.

In some embodiments, the partially reacted particles have a preferred crystallographic orientation after the further processing step (e.g., as a result of milling). Suitable methods of forming the such particles have been described in commonly-owned, co-pending U.S. Patent Publication No. US2007/0098803A1, entitled “Small Particle Products and Associated Methods,” published on May 3, 2007, which is incorporated herein by reference. In some embodiments, a majority (i.e., greater than 50%) of the particles in a composition may have the same crystallographic orientation. In other embodiments, greater than 75% of the particles, or even greater than 95%, or even substantially all, of the particles in a composition may have the same crystallographic orientation.

The preferred crystallographic orientation of the partially reacted particles may depend, in part, on the crystal structure (e.g., hexagonal, tetragonal) of the material that forms the particles. Crystals generally preferentially fracture along specific planes with characteristic amounts of energy being required to induce fracture along such planes. During milling, such energy results from particle/grinding media collisions. It is observed that, by controlling the energy of such collisions via milling parameters (e.g., grinding media composition, specific energy input), it is possible to preferentially fracture particles along certain crystallographic planes which creates a reaction product particle having a preferred crystallographic orientation.

In some embodiments, the preferred crystallographic orientation is defined by a basal plane (i.e., the plane which is perpendicular to the principal axis (c axis) in a tetragonal or hexagonal structure). For example, the basal plane, and crystallographic orientation, may be the (0001) or (001) plane.

Crystallographic orientation of particles may be measured using known techniques. A suitable technique is x-ray diffraction (XRD). It may be possible to assess the relative percentage of particles having the same preferred crystallographic orientation using XRD.

In some embodiments, milling the partially reacted particles may, itself, form the desired reaction product.

As noted above, the methods can include further reacting the partially reacted particles. This further reaction step can after the partially reacted particles are further processed (e.g., by milling) as described above.

The further reaction step is generally used to produce the desired reaction product. For example, the reaction product may be a lithium-based compound such as LiFePO₄, LiMnPO₄ and LiFeMnPO₄. The reaction product may have a desired phase. For example, the reaction product may have an olivine phase (e.g., substantially all of the product has an olivine phase, e.g., >95% or >99%). The desired reaction product and phase depends on the particular embodiment. Other reaction products are possible as noted above.

During the further reaction step, the partially reacted particles are heated to an appropriate temperature to cause a solid state reaction. For example, the partially reacted particles can be heated at a temperature of at least 400° C. (e.g., between 400° C. and 800° C.). In some cases, the precursors can be heated at a temperature of at least 600° C., at least 700° C. Other temperatures may also be used. The partially reacted particles may be heated for an appropriate time. Suitable times include between 1 and 4 hours, though other times are also possible.

As noted above, individual reaction product particles described herein may have a substantially uniform chemical composition. That is, the composition is substantially the same, or the same, throughout the volume of an individual particle (e.g., primary particle). For example, at least 50% of the individual reaction product particles may have a composition that is substantially uniform throughout an individual reaction product particle. In some cases, at least 10%, at least 25% , at least 40%, at least 60%, at least 70% , at least 80% , at least 90%, or greater, of the individual particles in the composition may have a substantially uniform composition throughout an individual particle. Suitable final reaction product particles have been described in commonly-owned International Patent Application Publication No. WO2009/082492 and U.S. patent application Ser. No. 12/342,043, filed on Dec. 22, 2008 and entitled “Small Particle Electrode Material Compositions and Methods of Forming the Same”, both of which are incorporated herein by reference.

In some cases, individual reaction product particles may be substantially uniform in that they are substantially free of undesired material (e.g., precursor particles, undesired byproducts) or substantially free of regions comprising undesired material. In some cases, at least 50% of the reaction product particles are substantially free of precursor material. In some cases, at least 60%, at least 70% , at least 80% , at least 90%, or greater, of the individual reaction product particles are substantially free of precursor material. As used herein, a composition “substantially free of precursor material” means a composition including less than 2% precursor material. In some cases, the reaction product particles have a composition having less than 1%, or essentially 0%, precursor material.

In some cases, a majority (e.g., at least 50%) of the individual reaction product particles may have a composition that is substantially free of byproducts. A byproduct refers to an undesired species that may be formed during a reaction between precursor particles to produce reaction product particles. Typically, the undesired byproduct material is a species that adversely affects certain properties of the reaction product particle. It should be understood, however, that some embodiments of the invention provide reaction product particles comprising additional materials (e.g., co-products) that improve and/or enhance properties of the reaction product particles, as described more fully below.

In an illustrative embodiment, a composition may include lithium iron phosphate reaction product particles produced via a reaction between a lithium-containing compound (e.g., lithium hydroxide, lithium carbonate) and iron phosphate. In the resulting composition, a majority (e.g., 50% or greater) of the lithium iron phosphate reaction product particles may have a composition that is substantially uniform throughout an individual reaction product particle, i.e., the individual particles are substantially free of regions rich in iron phosphate, regions rich in lithium, and/or regions rich other byproducts or precursor materials.

This composition uniformity on the particle level provides advantages over certain conventional reaction product particles (e.g., lithium-based compound reaction product particles), which have particles with heterogeneous composition due to, in some cases, incomplete and/or non-uniform reaction of precursor particles. For example, conventional lithium-based compound reaction product particles may include some regions rich in undesired byproducts and/or precursor particles, such as FePO₄. The presence of regions rich in undesired byproducts or precursor particles may, in some embodiments, adversely affect certain properties of the particles. In some cases, methods described herein may provide the ability to perform faster and more complete solid state reactions, wherein an increased amount of precursor particles are converted to the reaction product particle and formation of undesired byproducts is reduced, resulting in formation of a substantially uniform reaction product particle.

The uniformity of the composition of the reaction product particles may be observed using various techniques. In some cases, the presence and/or amount of region within the reaction product particles may be observed using X-ray diffraction (XRD) techniques. For example, the presence of heterogeneous regions within a bulk sample of reaction product particles may be indicated by the presence of an XRD peak. In some cases, compositional mapping techniques (e.g., EDS) may be used, where a voltage is applied to the reaction product particles to produce an image showing the location of specific atoms within the reaction product particles. The amount and/or distribution of the different types of atoms (e.g., metal atoms) over a sample may indicate the level of uniformity of the composition. For example, the homogeneous distribution of different types of metal atoms (e.g., Li, Fe, Mn, Co, Ni, etc) throughout the reaction product particles may indicate a substantially uniform reaction product particle, while the presence of relatively large, heterogeneous regions rich in one type of metal atom may indicate a reaction product particle that is not substantially uniform. The extent of uniformity may also be assessed using DSC (Differential Scanning Calorimetry) to analyze the reaction characteristics of the precursors.

In some embodiments, a majority of reaction product particles may also have substantially the same chemical composition. In some cases, at least 10%, at least 25%, at least 40%, at least 50%, at least 60%, at least 70% , at least 80% , at least 90%, or greater, of individual reaction product particles have substantially the same chemical composition. For example, in some cases, a substantial majority of the individual reaction product particles may include the product of a reaction, such as a solid-state reaction.

Some embodiments of the invention may also provide reaction product particles including various regions comprising a desired co-product. In some cases, the co-product may be formed during the reaction between precursor materials, in addition to a reaction product. In some embodiments, the co-product may be a conductive material. In some embodiments, the co-product may be an insulating material. In some embodiments, the co-product may be a magnetic material. In some cases, the co-product may provide stability (e.g., structural stability, electrochemical stability, etc.) to the reaction product particles. Using methods of the invention, the type and/or amount of co-products formed within the reaction product particles may be selected to suit a particular application. In an illustrative embodiment, lithium iron phosphate particles may be formed, wherein the particles include a iron(II) phosphate co-product.

It should be understood that the reaction product particles may also include suitable dopants which may enhance certain properties of the reaction product particles, including electrical conductivity. Examples of dopants include titanium, aluminum, etc.

In some embodiments, the final reaction step does not significantly change the particle characteristics. Thus, the final reaction product particles may have similar characteristics as those described above in connection with the partially reacted particles. Such characteristics include the above-described particle sizes, surface areas and morphology. For example, the final reaction product particles may have an average particle size of 500 nm or less; less than 250 nm, less than 150 nm, less than 100 nm, less than 75 nm, or less than 50 nm. In some embodiments, the final reaction product particles may be processed using the milling techniques described above to achieve such characteristics.

The reaction product particles may be further processed as desired for the intended application. For example, known processing techniques may be used to incorporate the particles in components (e.g., electrodes) used in electrochemical cells (e.g., batteries) as described above. The electrochemical cells (e.g., batteries) may be used in applications requiring small dimensions such as smart cards. In some embodiments, the particles may be coated with a thin layer of material (e.g., carbon). The carbon may be in the form of sp² carbon.

It should be understood that the reaction product particles may be used in any other suitable application and that the invention is not limited in this regard. Suitable coatings and related processes have been described in U.S. Patent Application Serial US-2008-0280141 which is based on U.S. patent application Ser. No. 11/712,831, filed Feb. 28, 2007, and is incorporated herein by reference.

Amongst other advantages, the methods can enable inexpensive and efficient production of compounds. In some cases, the partially reacted particles are processed to include characteristics (e.g., small size and/or morphology of the partially reacted particles) that can lead to a more complete reaction as well as a more homogeneous (e.g., uniform chemical and structural composition) reaction product particle. In some embodiments, lithium-based compounds may be produced having excellent electrochemical properties such as capacity, improved thermal stability, and extended charge/discharge cycling lifetimes. The methods described herein are repeatable, scalable, and may improve the consistency, manufacturability, and cost of material production.

The following examples are intended to be illustrative and are not limiting.

### EXAMPLE

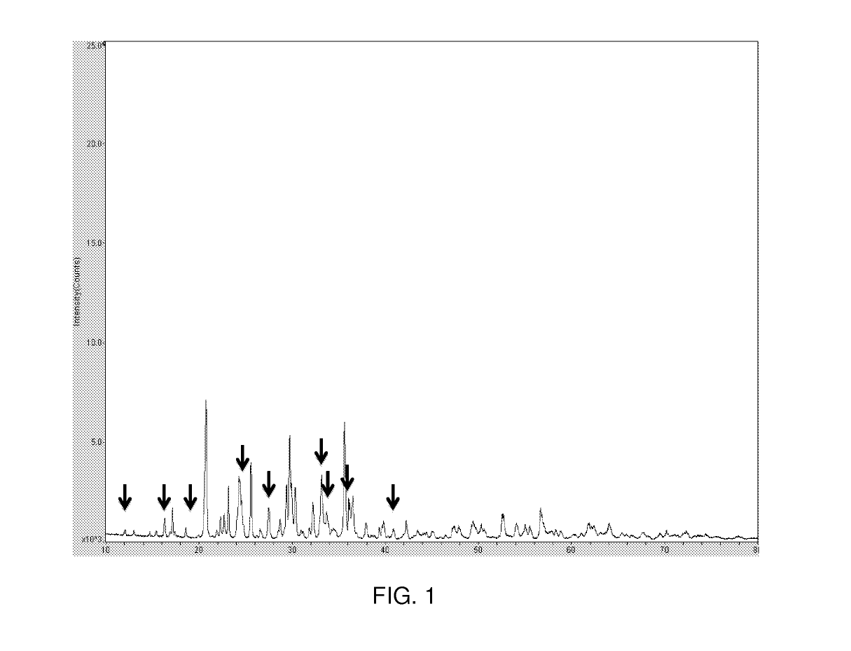

The following example describes the production and characterization of a lithium iron phosphate particle composition using methods described above. The material was prepared from precursor materials including FePO₄, Li₂CO₃, and cellulose acetate using the following general procedure. 748 g FePO₄, 149.4 g Li₂CO₃, and 16.6 g cellulose acetate were dry blended using a jar mill with zirconia grinding media for 1 hour. This blended material was partially reacted in a furnace at 650° C. for 2 hours in an inert gas. XRD analysis showed that the resulting composition was a partially reacted material. FIG. 1 is an XRD scan showing the presence of a LiFePO₄ phase, along with a substantial amount of impurity phases (indicated by arrows)—Fe₂O₃, Fe₃O₄, Li₃PO₄, Fe₂P₂O₇, Fe₃PO₇, FeO, Fe₃Fe₄(PO₄)₆, Fe(PO₄)₂, Li(Fe₅O₈), Li₃Fe₂(PO₄)₃. SEM analysis determined the average particle size of the partially reacted particles to be about 5 microns.

250 g of partially reacted material was added to 850 g distilled H₂O containing 2% Ascorbic Acid (by weight of solids) for 22.7% solids with manual stirring. The slurry was further processed using three milling steps. In the first milling step, the slurry was loaded in a MiniCER mill from Netzsch using Yttria Stabilized Zirconia media. The agitator speed used was 2400 rpm. The specific milling energy input (measured in kilojoules per kilogram of starting solids) of 10,000 KJ/Kg was used. The second milling step involved processing the slurry in a LabStar mill from Netzsch using multi-carbide grinding material. Three different samples of the material was processed at 2000 rpm at three different three energies—10,000 KJ/Kg, 20,000 KJ/Kg, and 45,000 KJ/Kg. The three samples were further processed in a third milling step which used multi-carbide grinding media in a MiniCER mill from Netzsch at 2400 rpm and a specific milling energy input of 10,000 KJ/Kg.

After the final milling step, the three samples were spray dried and subjected to a final reaction step. The final reaction step involved heating to 650° C. for 2 hours in an inert gas.

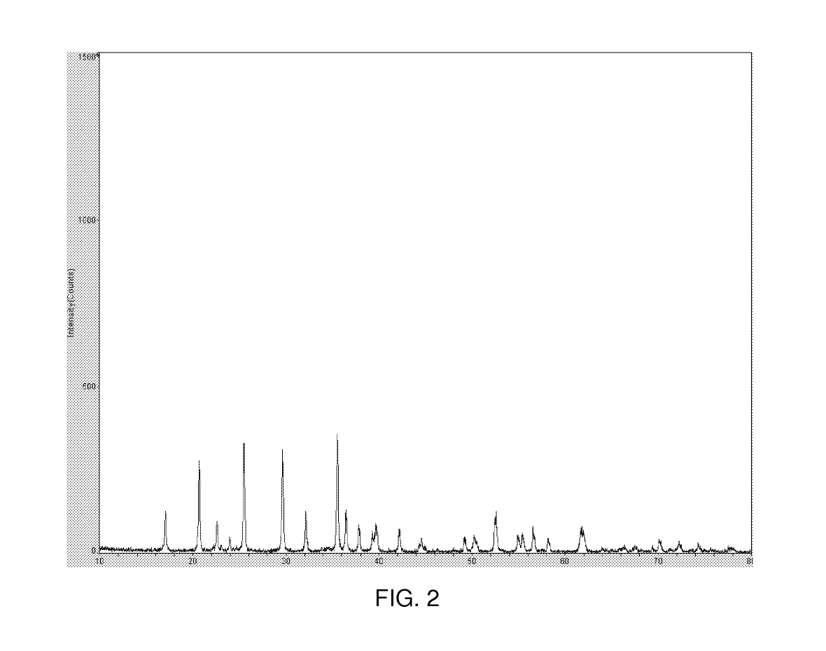

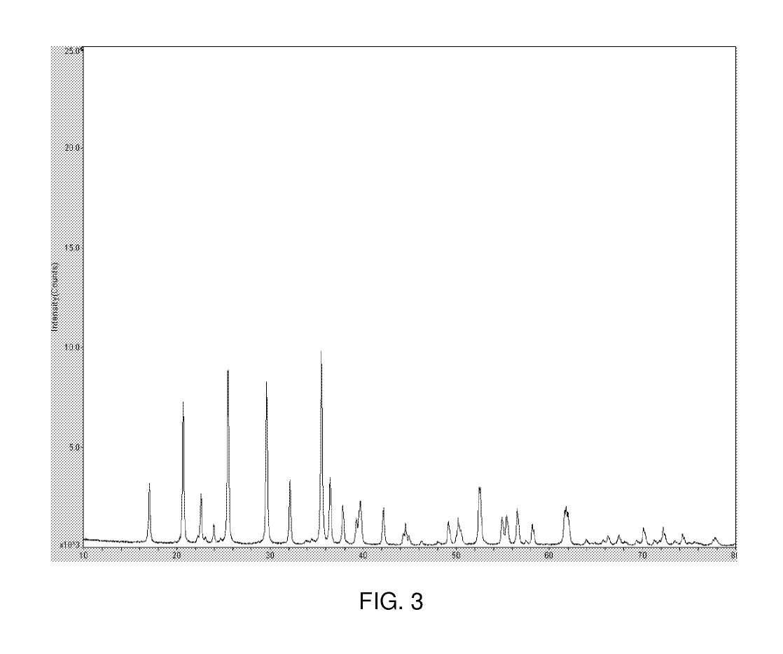

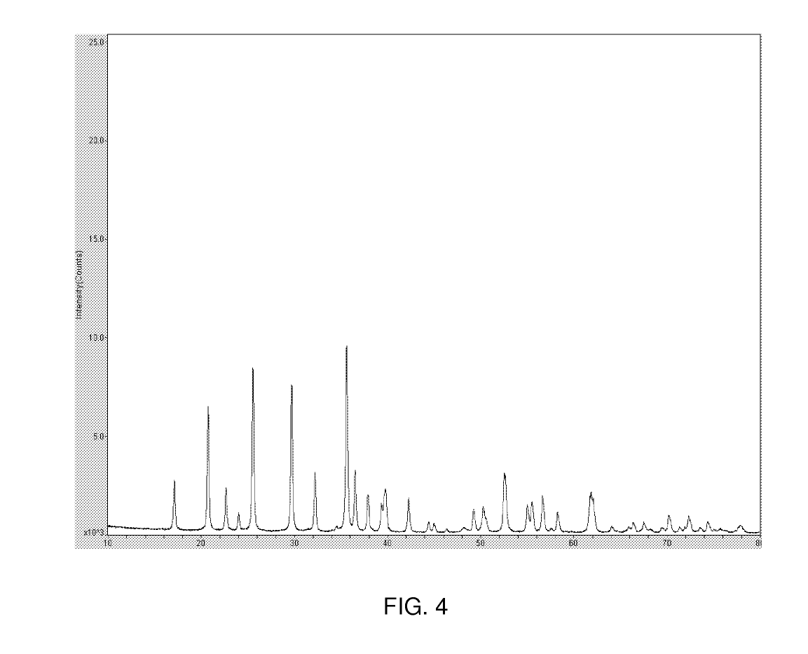

Each of the three samples was analyzed using XRD analysis. The XRD scan for the composition which included the 10,000 KJ/Kg second milling step is illustrated in FIG. 2 and shows a nearly pure LiFePO₄ with only minor impurity (Li₃PO₄) peaks. The XRD scan for the composition which included the 20,000 KJ/Kg second milling step is illustrated in FIG. 3 and also shows a nearly pure LiFePO₄ with only minor impurity (Li₃PO₄) peaks. The XRD scan for the composition which included the 40,000 KJ/Kg second milling step is illustrated in FIG. 4 and shows pure LiFePO₄ with essentially no impurity peaks. All three compositions had particle sizes on the order of 50 nm as determined by SEM analysis. All three had C/5 specific capacity values of 140 mAh/g, or greater.

This example illustrates that the methods described above can produce high quality lithium-based compound compositions.

Having thus described several aspects and embodiments of this invention, it is to be appreciated various alterations, modifications and improvements will readily occur to those skilled in the art. Such alterations, modifications and improvements are intended to be part of this disclosure, and are intended to be within the spirit and scope of the invention. Accordingly, the foregoing description and drawings are by way of example only.

What is claimed:

1. A method comprising:
reacting a first precursor with a second precursor to form a partially reacted composition; and
processing the partially reacted composition using a milling step.

2. The method of claim 1, further comprising further reacting the partially reacted composition to form a final composition.

3. The method of claim 2, wherein the final composition is a lithium-based compound.

4. The method of claim 1, wherein the milling step reduces the particle size of the partially reacted composition to an average particle size of less than 500 nm.

5. The method of claim 1, wherein the milling step reduces the particle size of the partially reacted composition to an average particle size of less than 100 nm.

6. The method of claim 1, wherein the milling step reduces the particle size of the partially reacted composition to an average particle size of less than 50 nm.

7. The method of claim 1, wherein the milling step produces a milled composition having a desired phase.

8. The method of claim 2, wherein the final composition is a lithium iron phosphate.

9. The method of claim 2, wherein the final composition includes greater than 20% by weight of an impurity phase.

10. The method of claim 2, wherein the final composition includes greater than 40% by weight of an impurity phase.

11. The method of claim 2, wherein the final composition includes greater than 60% by weight of an impurity phase.
